(19) United States
(12) Patent Application Publication
(10) Pub. No.: US 2012/0007408 A1
(43) Pub. Date: Jan. 12, 2012

(54) METHOD FOR PROTECTING AND RESTRAINING A PASSENGER OF A VEHICLE; AND PROTECTION AND RESTRAINING DEVICE FOR PROTECTING A PASSENGER OF A VEHICLE

(76) Inventors: Heiko Freienstein, Weil Der Stadt (DE); Armin Koehler, Sachsenheim (DE)

(21) Appl. No.: 13/143,912

(22) PCT Filed: Nov. 23, 2009
(86) PCT No.: PCT/EP2009/065602

§ 371 Date: Sep. 30, 2011

(30) Foreign Application Priority Data
Jan. 14, 2009 (DE) 102009000199.9

(51) Int. Cl. B60R 21/02; B60N 2/427

(52) U.S. Cl. 297/464

(57) ABSTRACT

A protection and restraining device for protecting a passenger on a passenger seat of a vehicle in the event of an accident, the protection and restraining device being designed to trigger a support wing such that it moves laterally against an occupant seat of the vehicle, and the protection and restraining device and/or support wing furthermore being designed to be more easily moved from a lateral initial position in a first lateral direction than in a second lateral direction.

### FIELD OF THE INVENTION

The present invention relates to a method for protecting and restraining a passenger of a vehicle, a computer program, a control device, and a protection and restraining device for protecting a passenger of a vehicle.

### BACKGROUND

In the event of a vehicle accident (in the following, also alternatively referred to as “crash”), the passengers are often thrown from their seats and get hurt on equipment objects of the vehicle interior. To prevent this, restraining systems are used, which restrain the passengers in the appropriate positions (such as on a vehicle seat). In addition to traditional restraining systems such as airbags or restraint belts and belt pretensioners, precrash systems having seat-based actuators are known in the related art, as disclosed, for example, in a general description of an actuator system in International PCT Application Publication No. WO 2004103779 A1.

In order to implement the most effective passenger protection possible, potential causes of severe injuries should be discussed at the outset. According to the publication of Tencer et al. (Factors affecting pelvic and thoracic forces in near-side impact crashes: A study of US-NCAP, NASS, and CIREN data, Accident Analysis and Prevention 37 (2005), 287-293] these causes may be summarized as follows:
Contact is made between a passenger and intruding door structures in the intrusion zone; in particular, the injury severity of the passengers correlates with the speed at which the door structures intrude into the vehicle interior.
High forces occur, which arise from intruding and projecting stiff door structures (e.g., from armrest elements) and act on the body of passengers.
Pelvic girdle fractures occur, which arise through passengers being jammed between the vehicle console and intruding door structures.

To keep passenger injuries to a minimum, the following aspects in the course of an accident should be taken into account in order to prevent as many causes of injury as possible or to reduce the risk of injury to the largest extent possible:
Passengers should be protected in the event of rollover events and lateral collisions (that is, collisions of a vehicle with the side of another vehicle, in particular taking into account a distinction between a lateral collision on a “near side” and a “far side” with regard to the respective seated position of the passenger in the vehicle), and in secondary accidents.
A passenger should be protected from crush injuries that have severe or fatal injury consequences.

### SUMMARY

Against this background, the present invention introduces a protection and restraining device, a method for protecting and restraining a passenger of a vehicle, furthermore a control device which uses this method, and finally a corresponding computer program product. Advantageous refinements are yielded from the following description.

The present invention provides a protection and restraining device for protecting a passenger on a passenger seat of a vehicle in the event of an accident, the protection and restraining device including at least one support wing which may be positioned in the vehicle such that the support wing may be moved laterally around a passenger seat of the vehicle. Furthermore, when disposed in an initial position, laterally with regard to the passenger seat, the support wing may be designed to exert a lower mechanical counterforce in response to an object that presses on the support wing from the direction of the passenger seat in an excursion by a predefined excursion path from the initial position in the direction away from the passenger, than is exerted on an object that presses the support wing from the initial position in the direction of the passenger seat by a predefined excursion path.

Furthermore, the present invention creates a protection and restraining device for protecting a passenger on a passenger seat of a vehicle in the event of an accident, the protection and restraining device being designed to control a support wing such that it moves laterally on a passenger seat of the vehicle, and the protection and restraining device and/or support wing furthermore being designed to be more easily moved out of a lateral initial position in a first lateral direction than in a second lateral direction.

Furthermore, the present invention creates a method for protecting and restraining a passenger on a passenger seat of a vehicle in the event of an accident with the aid of at least one support wing, the method including the following steps:
Moving the at least one support wing in the vehicle such that the support wing is situated in an initial position on the side of a passenger seat of the vehicle; and
exerting, via the support wing, a mechanical counterforce against an object that presses against the support wing; in the event of an excursion of the support wing by a predefined excursion path, from an initial position in a direction away from the passenger seat, a smaller mechanical counterforce is exerted on the object than in the event of an excursion of the support wing by the predefined excursion path from the initial position in the direction of the passenger seat.

The present invention also creates a method for protecting and restraining a passenger on a passenger seat of a vehicle with the aid of at least one support wing in the event of an accident, the method including the following steps:
triggering a movement of the at least one support wing in the vehicle such that the support wing moves into an initial position on the side of a passenger seat of the vehicle; and
exerting, via the support wing, a mechanical resistance against an object, the mechanical resistance in a first lateral direction being greater than in a second lateral direction.

The present invention also provides a control device designed to implement the above-described method. In the case at hand, a control device is an electrical device which processes sensor signals and outputs control signals as a function thereof. The control device may have an interface, which is implementable as hardware and/or software. In a hardware design, the interfaces may, for example, be part of a so-called system ASIC which contains various functions of the control device. However, it is also possible for the interfaces to be separate, integrated circuits or to be at least partially made up of discrete components. In a software design the interfaces may be software modules which are present on a microcontroller in addition to other software modules, for example.

A computer program product having program code stored on a machine-readable medium such as a semiconductor memory, a hard-disk memory or an optical memory is also advantageous, which is used to implement and/or trigger steps of the method according to one of the specific embodiments described above when the program is executed in a control device.

The present invention is based on the knowledge that the risk of injury in an accident may be reduced for a vehicle passenger if the vehicle passenger is restrained on the seat and therefore stabilized. This may be achieved through the provision and use of a support wing, which is extended and positioned on the side of the passenger seat in the event of an accident. In particular, this support wing is advantageously extended in the proximity of the seat back of the passenger seat, in order to restrain the heavy upper body of the passenger on the seat. This support wing thus prevents the passenger, in particular the upper body of the passenger, from slipping laterally from the seat, so that the optimal effect of the passenger safety means installed in the vehicle (such as an airbag, for example) may be ensured, since these passenger safety means are configured in a special way in order to optimally protect a vehicle passenger who is situated in a correct seated position. At the same time, however, the special configuration of the support wing ensures that a high counterforce opposes objects that disconnect from the external structure of the vehicle in the event of an accident and are hurled in the direction of the passenger seat. Likewise, a high counterforce against an intrusion of objects in case of a deformation of the passenger compartment is ensured. Thus, the support wing makes it possible to protect the passenger against intruding vehicle parts. However, at the same time, the design of the structure of the support wing also ensures that the support wing exerts a relatively small counterforce on a passenger of the vehicle when the passenger is pressed against the support wing by the impact of the accident. This prevents the passenger from being injured by the support wing in case of an accident (for example, when a safety means malfunctions).

The present invention provides the advantage that through the provision and use of the special support wing, an increase in safety with regard to a plurality of risks of injury is possible in a compact and simple manner. On the one hand, the support wing which is able to be placed on the side next to the passenger seat may hold the passenger in a desired seat position, and on the other hand, the special structure of the support wing may ensure great protection (through the provision of a high counterforce) against intruding vehicle parts, and at the same time great protection (through the provision of an only slight counterforce) against injuries of the passenger on the support wing.

It is advantageous if the support wing, when placed laterally with regard to the passenger seat, is designed to oppose a movement of the support wing from the initial position in a direction away from the passenger seat by a counterforce in accordance with a first force excursion characteristic, and to oppose a movement from the initial position in the direction of the passenger seat by a counterforce in accordance with a second force excursion characteristic; when reproducing the first and second force excursion characteristics in a force excursion characteristic diagram, the first force excursion characteristic is representable asymmetrically to the second force excursion characteristic, in relation to an initial position of the supporting wing that is representable in the origin of the force excursion diagram. This asymmetrical excursion characteristic, in particular, makes it possible to increase the safety of the passenger in that it becomes possible to fend off intruding objects using a “stiff” force excursion characteristic, while an injury of the passenger through an impact of this passenger on the support wing is prevented or lessened using a “soft” force excursion characteristic.

In addition, the support wing may be designed to oppose an object by at most a predefined maximum force when the object is moving from the passenger seat in the direction of the support wing. Due to the fact that the support wing opposes a passenger by at most a predefined maximum force, biomechanical requirements may be complied with, in order not to exceed the maximum tolerable lateral forces for a human. For example, if a passenger cannot be held in a correct seat position because of the failure of additional passenger protection means, then an injury of the passenger on the support wing that is certain to occur may be avoided or at least significantly reduced by this means.

In an additional specific embodiment of the present invention, the support wing may include a plurality of bars connected to each other, the bars each having a broad side and a narrow side opposite the broad side; the narrow side may be placed such that it faces the passenger seat and the broad side such that it faces away from the passenger seat. In this manner, using a construction that is mechanically very simple, it is possible to ensure that an object moving toward a passenger seat is opposed by a high counterforce, whereas an object (for example, the passenger) that moves away from the passenger seat is opposed by a lower counterforce. The high counterforce comes about in that wedge-shaped gaps arise between the bars made up of (hard) metal or plastic, for example, which are pressed together by the arriving object moving in the direction of the passenger seat. This causes the lateral faces of the bars to be pressed against each other until they no longer yield, so that the supporting wing transforms into a type of “armor.” However, if an object from the direction of the passenger seat hits the support wing, the wedge-shaped gaps grow, which does not produce a high counterforce.

Furthermore, in another specific embodiment of the present invention, the bars may also be connected to each other by joints in the region of their broad side. Such a specific embodiment of the present invention provides the advantage that a type of “hinge” is formed by the links in the region of the broad side, which additionally increases the stability of the support wing when an object from outside of the support wing moves in the direction of the passenger seat.

Furthermore, the support wing may also include a cloth material which at least partially connects the narrow sides of the bars. Such a specific embodiment of the present invention provides the advantage that on the one hand, it is possible to prevent body parts from ending up between the bars and thus jamming the passenger in the gaps, and on the other hand, it is possible to achieve a situation in which the bars are held together through the cloth when an object such as the passenger is pressed against the support wing. By this means, at least a slight counterforce of the support wing is made possible when an object from the direction of the passenger seat hits the support wing, so that this object is decelerated.

In order to ensure that the biomechanically predefined maximum lateral acceleration and a resulting force on a human are not exceeded, the cloth material may be designed to rip at a predefined maximum force (which advantageously corresponds to this maximum lateral acceleration to be endured by a human or the force resulting from this lateral acceleration).

In another specific embodiment of the present invention, the support wing may be electrically movable. To this end, sensors and actuators may be provided which electrically move the support wing. Such a specific embodiment of the present invention provides the advantage that a counterforce of the support wing on an object moving in the direction of the passenger seat or moving away from it is adjustable to a specific application environment in a precise and variable manner.

It is particularly advantageous if the force of the support wing is provided via an electromotor. This offers the advantage of a fast but still sufficiently precise adjustment option for the (counter) force exerted on the object by the support wing.

In an additional specific embodiment of the present invention, the restraining and protection device may include an interface to a sensor, via which information about a physical size of a passenger on the passenger seat may be received; furthermore, the support wing is designed to oppose an object that is moving from the passenger seat in the direction of the support wing by a mechanical force that is a function of the received physical size of an object. Such a specific embodiment of the present invention provides the advantage that the counterforce exerted by the support wing on the arriving object in the event of accident may be adjusted as a function of the passenger. This allows for a precise adjustment of the protective action offered by the support wing and thus a reduction of the individual risk of injury of the vehicle passenger in case of an accident.

In order to obtain the best possible protection of the passenger on the passenger seat, the restraining and protection device may have a second support wing which may be placed in the vehicle such that the second support wing is laterally movable around the passenger seat of the vehicle on a side of the passenger seat opposite the support wing; furthermore, when situated in an initial position laterally with regard to the passenger seat, the second support wing is designed to exert a lower mechanical counterforce on an object pressing against the second support wing from the direction of the passenger seat in an excursion by a predefined excursion path from the initial position in the direction away from the passenger seat, than on an object pressing on the second support wing by the predefined excursion path from the initial position in the direction of the passenger seat. Such a specific embodiment of the present invention provides the advantage that the passenger is restrained on both sides on the passenger seat, so that the risk of injury may be minimized regardless of the side of the impact of an object on the vehicle in question.

In order to obtain a restraining and protection device that is as compact as possible yet highly effective at the same time, and which is extendable into the desired position quickly and reliably in an accident, it is possible to extend or unfold the support wing and/or the second support wing from a backrest or a seat surface of the passenger seat.

In the following, the present invention is explained in greater detail by way of example, with reference to the attached drawing.

### BRIEF DESCRIPTION OF THE DRAWINGS

FIGS. 1a and 1b are representations of a schematic placement of the support wing in accordance with an exemplary embodiment of the present invention with regard to a person sitting on a passenger seat.

FIG. 2 is a representation of an exemplary force excursion characteristic in accordance with an exemplary embodiment of the support wing and the protection and restraining device.

FIGS. 3a to 3c are representations of the connection of individual elements of the support wing in accordance with an exemplary embodiment of the present invention.

FIG. 4 is a schematic representation of a support wing in accordance with another embodiment of the present invention.

FIG. 5 is a flow chart of an exemplary embodiment of the present invention as a method.

### DETAILED DESCRIPTION

Identical or similar elements may have the same or similar reference numerals in the following figures. Furthermore, the figures in the drawing, their description and the claims contain numerous features in combination. In this context, it is clear to one skilled in the art that these features may also be considered individually or may be combined to form further combinations not explicitly described here. The dimensions and sizes named in the following are used only to illustrate the description of the present invention and are not to be understood as a restriction of the present invention to these sizes and dimensions.

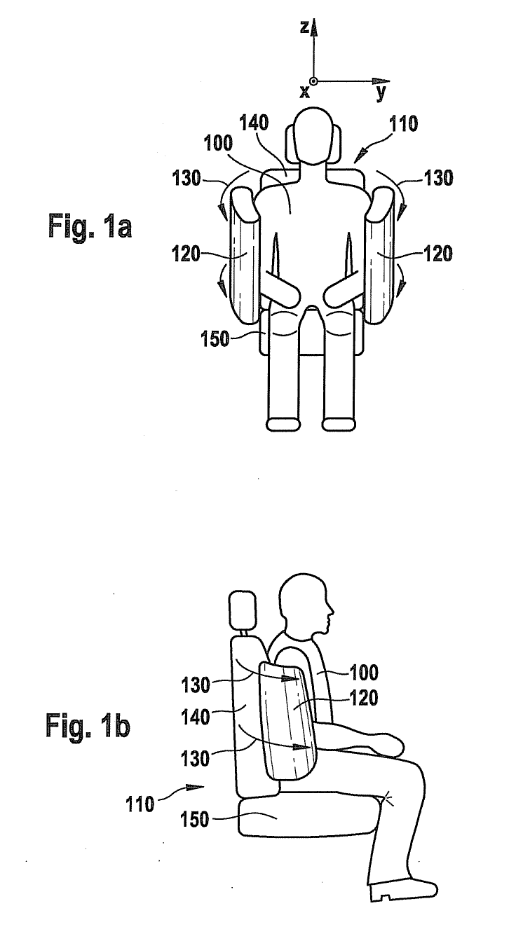

FIG. 1 shows representations of a schematic placement of the support wing in accordance with an exemplary embodiment of the present invention with regard to a person sitting on a passenger seat. FIG. 1 shows a) a frontal view of passenger 100 or the person on passenger seat 110, one support wing 120 respectively being placed to the left and right (i.e., to the side) of passenger seat 110. This placement of support wing 120 may be accomplished by a fold-down movement 130 from a backrest 140 (or alternatively from a seat cushion 150 of passenger seat 110) when an accident or a collision of the vehicle with an object takes place. FIG. 1b) shows a side view of passenger 100, who is seated on passenger seat 110 and is laterally protected or restrained by an extended support wing 120. Support wing 120 may be connected by braces or supporting bars to an extension mechanism (not shown in FIG. 1) which extends the corresponding support wings 120 (either on one side or on both sides) in a situation that calls for a particular protection and restraint of passenger 100 on passenger seat 110. In the process, for example, a direction of the impact of an object on a vehicle also may be taken into account, so that support wings 120 do not necessarily have to be extended on both sides beside passenger seat 110, although this would result in a significant increase in the safety of passenger 100.

The structural design of a support wing 120, as illustrated in FIG. 1, is explained in greater detail in the subsequent figures, the explanation being based on the coordinate system illustrated in FIG. 1, in which the y-axis is illustrated in a horizontal direction toward the right, the z-axis is illustrated in a vertical direction toward the top, and the x-axis being illustrated in a direction out of the drawing plane.

Essentially, the exemplary embodiments of the present invention in the form of support wing 120 illustrated in this instance help to form a protective sheath (at least on one side) around the passenger in the precrash situations, this protective sheath having an intelligent force characteristic.

The present invention is based on a precrash sensor system (i.e., a surroundings sensor system) and/or an inertial sensor system, whose signals are evaluated by a logic as evaluation unit, for example. This evaluation unit releases as safety means, for example, a seat-based actuator which extends support wing 120 (for example, from back rest 140 or seat cushion 150) of the passenger seat into the position illustrated in FIGS. 1a and 1b (as an initial position).

The seat-based actuator represents a lateral protection and restraint device which takes on essentially three jobs:
The passenger is fixed in the vehicle seat such that, for example, belt and airbag may operate optimally and the passenger or the person on the passenger seat is kept out of the intrusion zone of objects into the passenger compartment.
Furthermore, the forces of intruding structures are optimally distributed on large surfaces, and
a crush injury of the rib cage and the pelvic region of the passenger may be prevented by forming a protective zone via support wing 120.

In the precrash case, the protection and restraint device, especially support wing 120 thereof, is extended from the seat (in particular, out of a backrest segment or also a seat segment) and forms a kind of sheath around the passenger. This may be formed completely or also partially, as can be seen in the exemplary illustration of FIG. 1.

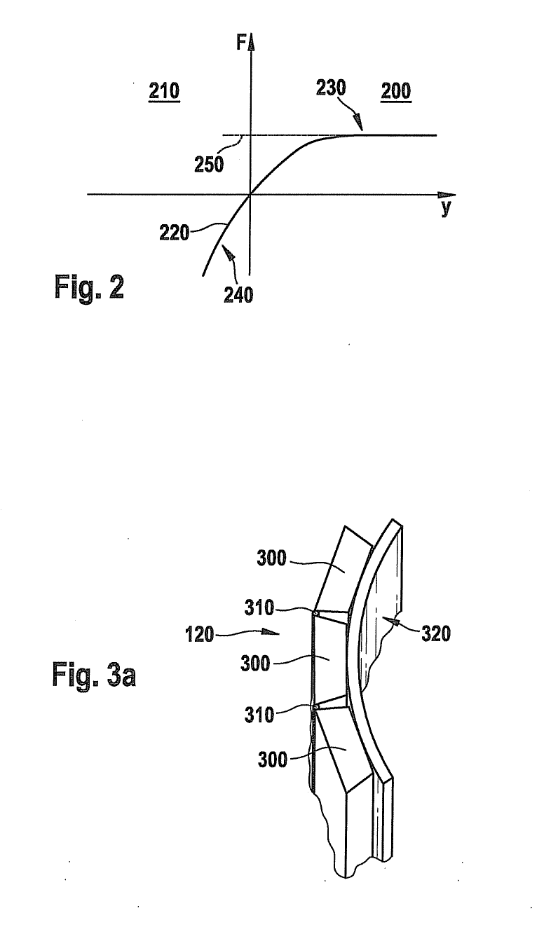

This protection and restraint device (which is also called “iRIB” in the following, which may be translated as “intelligent rib impact bolster”) protects against an intrusion of objects from outside (when passenger 100 sits inside); however, it allows for a yielding from the inside to the outside, in order to limit the load of the passenger in the event of high crash accelerations. This leads to an asymmetrical force-displacement characteristic, as illustrated in a force excursion diagram in accordance with FIG. 2, for example.

In the force excursion diagram in accordance with FIG. 2, an excursion in the y-direction (for instance, of support wing 120 on the left, from the perspective of the passenger, from FIG. 1a) is plotted on the abscissa. In this context, a neutral or initial position of support wing 120 is illustrated in the origin of the diagram. Thus, right diagram region 200 having positive excursion values (i.e., positive y-values) corresponds to an excursion away from the passenger, while left diagram region 210 having negative excursion values (i.e., negative y-values) corresponds to an excursion of the support wing toward the passenger. Ordinate F of the diagram illustrated in FIG. 2 reproduces a (counter) force with which support wing 120 opposes an object that causes corresponding excursion y. As may be seen from the force excursion diagram in accordance with FIG. 2, given the same excursion path in the positive y-direction, support wing 120 exerts a lower (counter)force on the object than it does in the event of the same excursion path in the negative y-direction. This results in the already mentioned asymmetrical force excursion characteristic and characteristic curve 220 in relation to the origin (i.e., this initial position of support wing 120) of the diagram from FIG. 2. This illustrates the advantageous “stiff” characteristic of the support wing (second force excursion characteristic 240), through which, in response to a movement of an object from outside in the direction of the passenger (for example, an intruding door part), this object is opposed by a high counterforce, in order to thereby reduce a risk of injury of the passenger to the greatest extent possible. At the same time, the force excursion characteristic 220 shown in FIG. 2 in the right-hand region of the diagram 200 (first force excursion characteristic 230) makes it clear that if an object makes contact with support wing 120 in the direction away from the passenger (for example, a person on the passenger seat who is pressed against the support wing by the momentum of the accident), support wing 120 has a “soft” characteristic. At the same time, it can be gathered from the force excursion characteristic 220 in the right-hand side of the diagram region 200 that counterforce F exerted by support wing 120 on the object does not exceed a maximum force 250 in case of an excursion away from the passenger. By this means, it may be ensured that support wing 120 opposes the passenger at most with this maximum force 250 in case of an impact of a passenger on support wing 120. This maximum force 250 may be predefined in a fixed manner and orient itself on corresponding guidance values for a maximum acceleration to be sustained by a person. However, as an alternative it is possible to provide a sensor which ascertains a physical size of the passenger (such as, for example, a weight of the passenger), and accordingly adjusts maximum force 250 on the basis of this size. For example, it may be assumed that heavy persons have a certain pad of fat that achieves an additional absorbing of an impact.

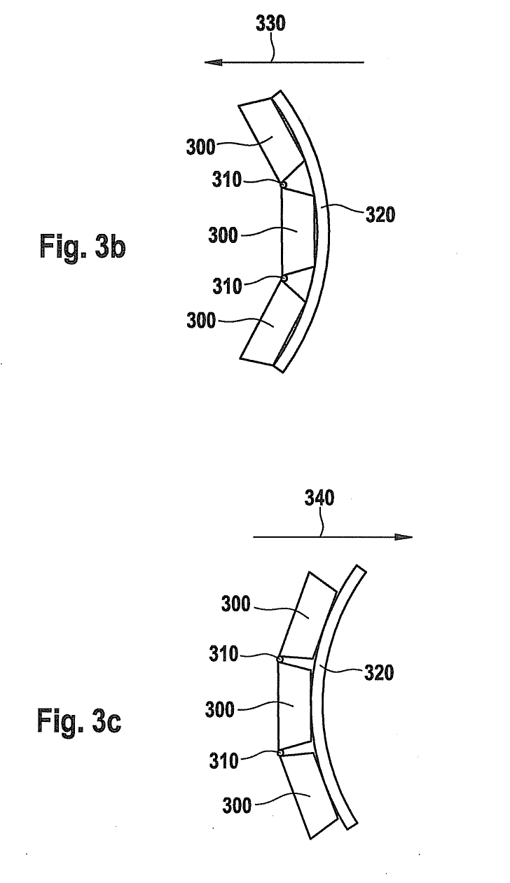

The force excursion characteristic shown in FIG. 2 may be implemented using purely mechanical means, as shown in FIGS. 3a to 3c, for example. In all partial figures of FIG. 3, an exemplary construction is illustrated that forms the lateral sheath (or support wing 120) by connecting different bars 300 or rods. Bars 300 may be formed from a rigid, i.e., non-malleable, material and have, for example, a trapezoidal cross section. Bars 300 may be disposed in support wing 120 such that the narrower of the two broadest sides faces the passenger and the broader of the two broadest sides faces away from the passenger. In this manner a wedge-shaped gap is formed at the lateral faces between rods 300 (which are normally the two narrowest sides of bars 300), which allows for a movement of individual bars 300 around an axis in the longitudinal direction of bars 300. It is advantageous to use joints 310 on the side facing away from the passenger (in the longitudinal direction of the bars), while a covering. 320 (made of elastic material, for example) is present on the side facing the passenger. First of all, this covering ensures that no body parts of the passenger are jammed in the wedge-shaped gaps, and secondly, it ensures that if passenger 100 is pressed against support wing 120, a certain counterforce acts on passenger 100 and the passenger is thus intercepted when being hurled against support wing 120.

When support wing 120 or interconnected bars 300 are bent away from the passenger (i.e., if an object, such as a passenger, for example, moves in a direction 330 to the left, in accordance with FIG. 3b), elastic covering 320 operates with a relatively low force. Joints 310 follow the movement and allow bars 300 to bend away from the passenger. When support wing 120 or connected bars 300 bend toward the passenger (i.e., if an object, such as an intruding door part, for example, moves in a direction 340 from outside to the right toward the passenger in accordance with FIG. 3c), the material constants of connected “stiff” bars 300 or joints 310 placed on the side facing away from the passenger take effect. In this manner, joints 310 do not allow for a free movement in this movement direction, so that the stiff material dominates and a high counterforce is exerted on an object that moves in this direction 340.

Alternatively, the bars may also have a block-shaped cross section, so that no wedge-shaped gaps arise in the “straight” initial position of a support wing 120 constructed in this manner. In this case, however, support wing 120 is unable to form a protective sheath around a passenger, but rather at most an essentially flat surface that is situated between the passenger seat and a vehicle door, for example. However, the above-described protective effect in the event of objects that move toward a passenger or move away from a passenger is also achievable using a support wing 120 that is formed by bars having block-shaped or rectangular cross sections.

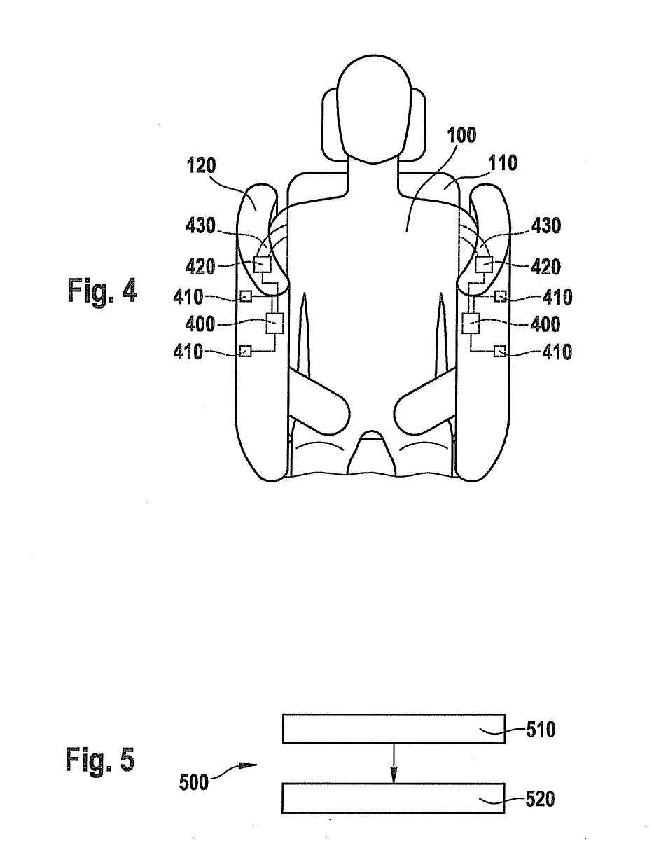

Furthermore, the force excursion characteristic shown in FIG. 2 may also be realized by a triggering 400 of the actuator (i.e., the protection and restraint element), provided the latter has suitable degrees of freedom and an interface for signals of a suitable sensor system. Such an embodiment of the present invention is represented by way of example in FIG. 4. For instance, in one such exemplary embodiment, an object's force on the support wing may be detected directly via force sensors 410 and pressure sensors (which are installed on a surface on support wing 120 facing the passenger or on a surface facing away from the passenger); furthermore, it is possible to transmit to control unit 400 the pressure or the force an object is exerting on support wing 120. The corresponding counterforce of the support wing may then be provided, for example, in response to a signal from triggering unit 400, by an electromotor 420, which supports itself against a restraining or extendable bar 430 of support wing 120. Alternatively or additionally, the force exerted on support wing 120 may also be detected indirectly via the current consumption of electromotor 420 (for example, in the case of an electromotor 420 that constantly receives a basic current). Furthermore, in one exemplary embodiment in accordance with FIG. 4, a special force excursion characteristic may be implemented or made adjustable, that is to say, a characteristic of the characteristic curve that is personalized to a specific passenger of the vehicle is able to be realized (key word: individual safety). In this case the characteristic curve may be adjusted (for example, to the size or the weight of the particular passenger), so that a reduction of the risk of injury is adaptable by adjusting to the special anatomical forms and properties of the particular passenger. For example, for a robust person, a powerful restraining force (toward the outside) may be selected (optimal crash kinematics), whereas a person of more advanced age may be intercepted gently, so that he/she is not injured by the actuator.

FIG. 5 shows a flow chart of an exemplary embodiment of the present invention as method 500 for protecting and restraining a passenger on a passenger seat of a vehicle in the event of an accident with the aid of at least one support wing. In this context, method 500 has a first step of moving 510 the at least one support wing in the vehicle such that the support wing is situated in an initial position to the side around a passenger seat of the vehicle. Furthermore, method 500 includes a step of exerting 520 a mechanical counterforce via the support wing, against an object that presses against the support wing; if an excursion of the support wing by a predefined excursion path takes place from an initial position in a direction away from the passenger seat, a smaller mechanical counterforce is exerted on the object than in case of an excursion of the support wing by the predefined excursion path from the initial position in the direction of the passenger seat.

1 to 14. (canceled)

15. A method for protecting and restraining a passenger on a passenger seat of a vehicle in the event of an accident with the aid of at least one support wing, the method comprising:
triggering a movement of the at least one support wing in the vehicle such that the support wing moves into an initial position on a side of a passenger seat of the vehicle; and
exerting a mechanical resistance against an object via the support wing, the mechanical resistance being greater in a first lateral direction than in a second lateral direction.

16. A device comprising:
a control device configured to at least one of (a) implement and (b) trigger the steps of the method of claim 15.

17. A non-transitory computer-readable medium comprising:
a set of instructions executable by a data processor to at least one of (a) implement and (b) trigger the steps of the method of claim 15.

18. A protection and restraining device for protecting a passenger on a passenger seat of a vehicle in the event of an accident, comprising:
a support wing, the protection and restraining device being configured to trigger the support wing such that the support wing moves laterally along a passenger seat of the vehicle, the support wing being further configured to be more easily moved from an initial lateral position in a first lateral direction than in a second lateral direction.

19. The protection and restraining device as recited in claim 18, wherein the protection and restraining device is configured to oppose an object in a movement from the passenger seat in the direction of the support wing by no more than a predefined maximum force.

20. The protection and restraining device as recited in claim 18, wherein the support wing has a plurality of interconnected bars, the bars each having a broad side and a narrow side situated opposite the broad side, and the narrow side is configured to be positioned toward the passenger seat and the broad side is configured to be positioned to face away from the passenger seat.

21. The protection and restraining device as recited in claim 20, wherein the bars are interconnected by joints in the region the respective broad sides.

22. The protection and retaining device as recited in claim 20, wherein the support wing includes a cloth material which at least partially connects the narrow sides of the bars.

23. The protection and restraining device as recited in claim 22, wherein the cloth material is designed to tear at a predefined maximum force.

24. The protection and restraining device as recited in claim 18, further comprising:
an actuator configured to (a) electrically move the support wing towards an object or (b) electrically induce a force of the support wing towards the object.

25. The protection and restraining device as recited in claim 24, wherein the protection and restraining device is configured to provide a force exerted by the support wing towards an object via an electric motor.

26. The protection and retaining device as recited in claim 24, further comprising:
an interface to a sensor, via which information about a physical quantity of a passenger on the passenger seat is able to be received, the protection and restraining device being configured to control the support wing in such a way that an object making a move from the passenger seat in the direction of the support wing is opposed by a mechanical force that is a function of the received physical quantity.

27. The protection and restraining device as recited in claim 18, wherein the support wing is a first support wing and the protection and restraining, device is configured to control a second support wing in such a way that the second support wing moves laterally to the passenger seat of the vehicle on a side of the passenger seat lying across from the first support wing, and the second support wing is configured to be controlled to make movement from an initial lateral position in the first lateral direction more difficult than in the second lateral direction.

28. The protection and restraining device as recited in claim 27, wherein at least one of (a) the first support wing and (b) the second support wing is extendable or able to be folded down from a backrest or a seat surface of the passenger seat.
